(19) United States
(12) Patent Application Publication
(10) Pub. No.: US 2012/0141046 A1
(43) Pub. Date: Jun. 7, 2012

(54) MAP WITH MEDIA ICONS

(75) Inventors: Bill Chen, Bellevue, WA (US); Eyal Ofek, Redmond, WA (US)

(73) Assignee: Microsoft Corporation, Redmond, WA (US)

(21) Appl. No.: 12/957,424

(22) Filed: Dec. 1, 2010

(51) Int. Cl. G06K 9/36

(52) U.S. Cl. 382/282

(57) ABSTRACT

The claimed subject matter provides a method and system for generating a map. An exemplary method includes selecting a media item from a plurality of media items. The media item may be relevant to the map and to an interest of a user. The method also includes selecting a segment from the media item, the selected segment being relevant to the interest of the user. Additionally, the method includes creating a distorted segment based on the selected segment. The selected segment may be distorted to facilitate positioning the distorted segment in the map. The method further includes compositing the distorted segment into the map as a media icon.

### BACKGROUND

Digital maps generally represent a realistic interpretation of the underlying geography. One approach used by web services shows maps composed of aerial photographs. Detailed features such as the terrain, building textures, and relative positions of the geography may be represented in a realistic view of the map. Unfortunately, the amount of detail shown in such maps may be overwhelming. The abundance of detail may obfuscate information that is relevant to a particular viewer of the map. Moreover, the map may not prove useful to a user who is interested in data relating to a particular place or event.

Other types of maps represent points that may be of interest to a user as icons that stand out from the surrounding detail. While such maps may show the relative positions of points of interest, it may still be difficult for a user to easily locate a physical location corresponding to an icon on the map.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for generating a map. The method includes selecting a media item from a plurality of media items. The media item may be relevant to the map and to an interest of a user. The method also includes selecting a segment from the media item, the selected segment being relevant to the interest of the user. Additionally, the method includes creating a distorted segment based on the selected segment. Moreover, the selected segment may be distorted to facilitate positioning the distorted segment in the map in a visually appealing or interesting manner. The method further includes compositing the distorted segment into the map as a media icon.

An exemplary system according to the subject innovation may be used for generating a map. The exemplary system comprises a processing unit and a system memory that comprises code configured to direct the processing unit to scale the segment to create a distorted segment. The code may also be configured to direct the processing unit to rotate the distorted segment to facilitate aligning the distorted segment to a portion of the map. The map may be three dimensional.

Another exemplary embodiment of the subject innovation provides one or more computer readable storage media that include code to direct the operation of a processing unit. In one exemplary embodiment, the code may direct the processing unit to select a media item based on an event that occurs in an area represented by the map. The event may be of interest to a user of the map. The code may further direct the processing unit to composite a distorted image of the segment into the map as a media icon, wherein the media icon travels within the map based on a changing location of the event.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a data flow diagram of a system for producing a map with browsing media in accordance with the claimed subject matter;

FIGS. 2-6 are exemplary digital maps produced in accordance with the claimed subject matter;

FIG. 7 is a process flow diagram showing a method of producing a map according to an exemplary embodiment of the claimed subject matter;

FIG. 8 is a block diagram of an exemplary networking environment wherein aspects of the claimed subject matter can be employed; and

FIG. 9 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “browser,” “client” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Typical digital maps may be realistic, composed of aerial photographs and the like. Digital maps may represent a geographical area, e.g., cities, neighborhoods, shown as compositions of images of streets, houses and other buildings. However, such maps are unlikely to include information relating to a particular event of interest, e.g., a marathon race taking place at a particular time. In addition, for a map in which all images are on the same scale, events of interest to a user, if represented on the map at all, may appear imperceptibly small.

Other maps that are less realistic, such as tourist maps, may also represent geographical areas and may include information about specific things of relevance to users. Moreover, sketches or other drawings that represent attractions, other major features, and even notable events. For example, the Battle of Gettysburg may be represented in a sketch located at its location on a map.

Non-photorealistic maps share several underlying principles. First, icons representative of events may be drawn enlarged, relative to other features of the map, to emphasize their visibility, and hence importance. Second, icons representative of events are not necessarily positioned with high accuracy, but with enough accuracy to determine relative positions. Moreover, the position of an event logo is influenced by its actual position, and its position relative to other features, events, etc. However, such maps cannot be updated, and may become irrelevant to the viewer. In an exemplary embodiment, an event might span a large area or a path (a race route), a hike). Such an event might be represented by multiple icons that represent the progress of the happenings of the event in different locations, or by a continuous long icon that spans the path.

In one exemplary embodiment, these principles may be applied to the domain of digital maps, though other map types may be used. Representations of events may be shown relative to their position in a digital map. The map may be realistic, including aerial photos of the geography. Further, the representations of events may be realistic, and may include information derived from a number of media sources in, for example, Internet and wireless communications. A segment from a media source may be selected to correspond to a location or event of interest to a user. The segment may be distorted in some way to make its incorporation into a map appealing in appearance. An example of distortion of a segment derived from a media source may include orienting the segment so that its incorporation into a map appears more realistic, as opposed to arbitrarily placing the segment in the map without regard to the relative orientation.

As used herein, a media icon may comprise a segment from a media source distorted for placement into a map. A media icon may also comprise a piece of video that shows a typical action on a particular spot, or live coverage of action as it occurs. Media icons, as spatially presented, may be a spatial distortion of either an iconic or image-based representation of an event. The media icons may represent, or otherwise describe an event in a two- or three-dimensional map. The media icon itself may be two-, three-, or even four-dimensional (given the capacity to occupy time on a map).

With media icons, maps may be generated that include representations of detail that would otherwise not be viewable in a to-scale map. Using such maps, real-time events such as baseball games, traffic jams, oil spills or even a tour of a famous city may be viewable in a way that allows a user to easily locate them.

As contextually presented, media icons may function as detail magnifiers. An event or detail about an area may be magnified in a media icon view, providing the details in a context plus detail user experience. Media icons may also be personalized to include experiences represented as photos, videos, and other media personal to the viewer or generator of the map.

In one exemplary embodiment, animated media icons may move on the map according to the motion of the event. For example, a media icon may include video images of traffic, as areas along a roadway become congested.

In some exemplary embodiments, the selection of media icons may be personalized. The media icons displayed on a map may be selected automatically based on predetermined preferences. The purpose is to provide a map that includes viewable, multi-media elements that are relevant to the viewer.

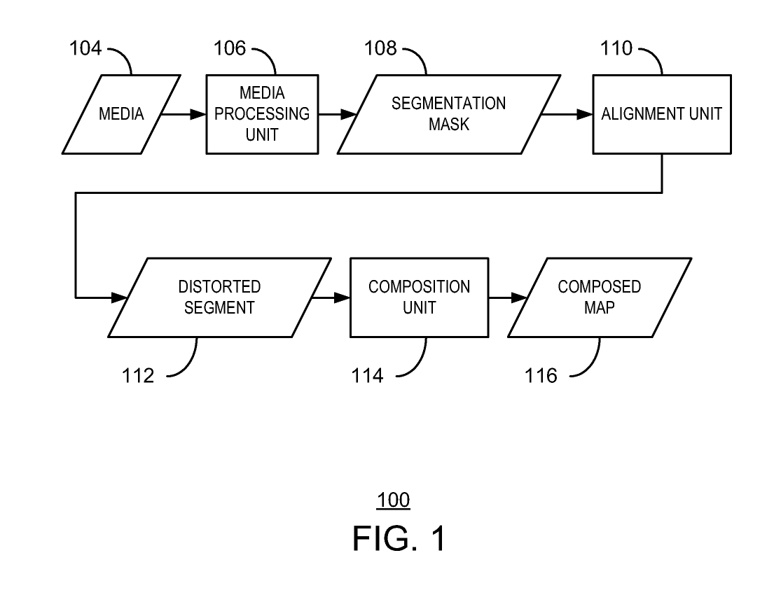

FIG. 1 is a block diagram of a system 100 for producing a map with media icons in accordance with the claimed subject matter. The system includes a plurality of media items 104, which may be analyzed and processed in a media processing unit 106. The media items 104 may include any number of types, such as images, video, and multimedia presentations. The media items 104 may be numerous and may be obtained from sources that include, for example, television and radio stations, newspapers, radios, blogs and other websites, RSS reeds, search engines, text messages, online chats, etc.

According to an exemplary embodiment, one or more of the media items 104 may be selected by the media processing unit 106 because of relevance to the viewer of the map. For example, if the viewer is a baseball fan, media items such as video of a baseball player hitting a homerun may be selected because it is relevant to the viewer.

A portion of a media item may be selected for visualization as a media icon in the map. Moreover, rather than using an entire image, e.g., the baseball field, part of the image, e.g., the baseball player, may be segmented out. Advantageously, a segment of an image derived from a media item and placed in the map's context may seem more natural than a block image.

In an exemplary embodiment, the media processing unit 106 is used to analyze a selected media item 104 by performing a pixel-by-pixel analysis. In this manner, a segment that relates to an interest of the user and a particular map may be selected. The selected segment may comprise an image taken from one of the media items 104. For example, a still image from video of the homerun may be analyzed for the particular pixels that represent the actual player and the bat used to make a hit. The set of pixels identified in the image form a segment that represents the event.

A segmentation mask 108 may be used to isolate an image from a media source that contains the media item. The segmentation mask 108 may comprise an array where each cell is a bit value that indicates whether or not the pixel is part of a segment, i.e., the pixels representing the event for that image/video. For example, a one value may indicate high confidence that the pixel is part of the baseball player or the bat. A zero value may indicate otherwise.

In some scenarios, it may not be possible to efficiently identify the representative bits. For example, players with green uniforms may be indistinguishable from a green, grass background. In such scenarios, the segmentation mask 108 may identify a region of the image, e.g., an oval shape, cropped from the larger image.

The segmentation mask 108 may be provided as input to an alignment unit 110. As explained herein, the alignment unit 110 may provide distortion to the selected segment to improve the appearance of the segment when inserted into a map as a media icon. The alignment unit 110 may determine how the segment is aligned and scaled to the map. A location of the feature may also be provided as input to the alignment unit 110. This location may be an approximation, and may include other information such as orientation. Orientation may indicate the direction from which a picture was taken, e.g., the camera was facing north.

Given the location and the segmentation mask 108, the alignment unit 110 may determine a distortion for aligning the selected segment to the map. Examples of distortion include simple rotation, scaling, perspective distortion, piecewise affine distortion and the like. Combinations of these distortion types are also possible. The distortion may be applied to the segment 108, generating a distorted segment 112.

The distorted segment 112 may be composited into a map as a media icon by a compositing unit 114. The compositing unit 114 may composite the distorted segment 112 into a composited map 116 in a plausible way. In other words, the composited map 116 may maintain semantics of the event while enabling viewing of the map for contextual cues. The compositing unit 114 may define the edges of the media icon that transition to the map images.

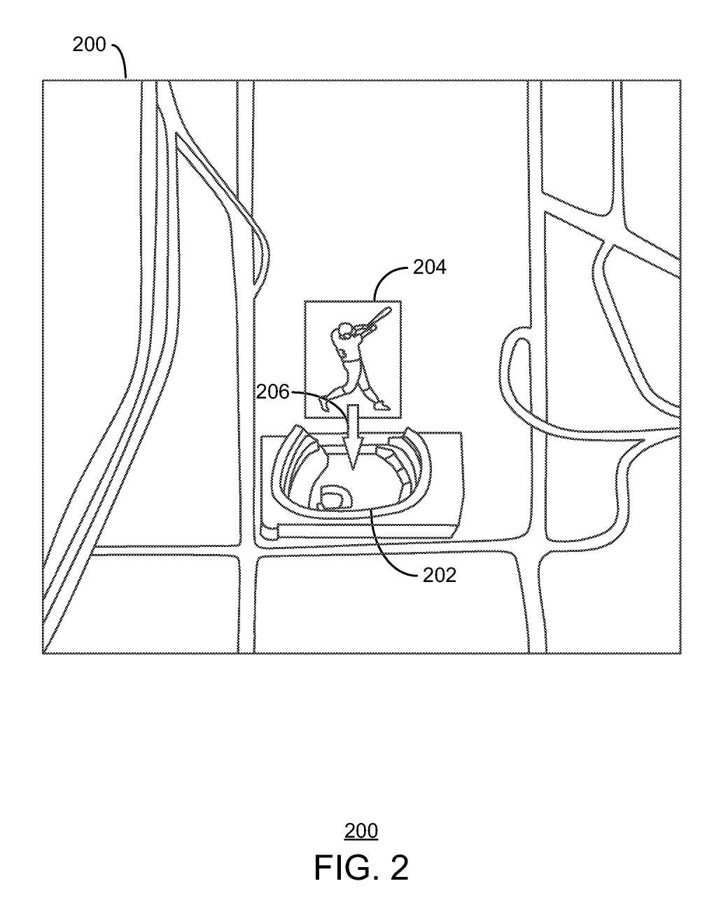

FIG. 2 is a digital map 200 in accordance with the claimed subject matter. The map 200 represents a city area with a sports venue, e.g., a baseball field 202. The map 200 includes a media icon 204 representative of an event at the baseball field 202. In the media icon 204, the player hitting the home run is shown in a bulletin board style. The map 200 also includes an arrow 206 indicating the event is taking place at the baseball field 202.

The digital map 200 shows an example of position and scale distortion performed by the alignment unit 110. The position of the player is moved to be above the field 202. The scale of the player is also enlarged in relative scale to the map 200.

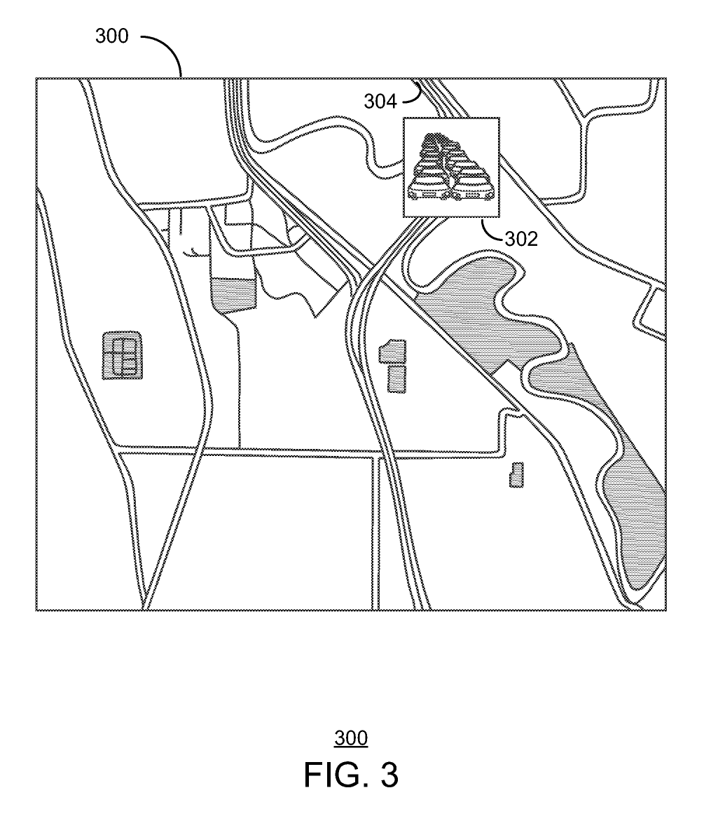

FIG. 3 is a digital map 300 in accordance with the claimed subject matter. The map 300 includes a media icon 302 with a distortion-based on rotation, scale and positioning alignment. Using these distortions, the media icon 302 of traffic is placed onto a road 304 of the map 300. The distortion of a selected segment may be dynamic over time, illustrating motion in the event itself. For example, areas of traffic congestion may appear at different positions of the map 300.

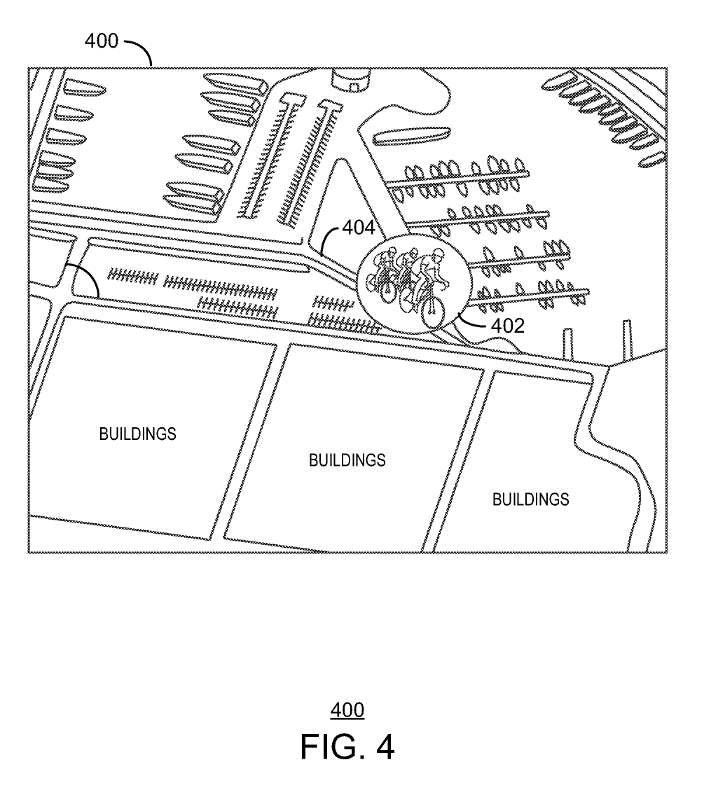

FIG. 4 is a digital map 400 in accordance with the claimed subject matter. In FIG. 4, a media icon 402 of a rider in a bike race may move along the road 404 being traveled to represent the rider's changing position. The media icon 402 may travel within the map 400, and may even pass into neighboring maps.

The media icon 402 may be based upon a segment from a media source that includes video, or other images, of the event. Based on distortion created by the alignment unit 110, the media icon 402 may be distorted via rotation to align video of the bike rider to the road 404.

In one exemplary embodiment, an animated media icon may be repeatable. The viewer may replay the media icon 402 travelling over a portion of the map 400.

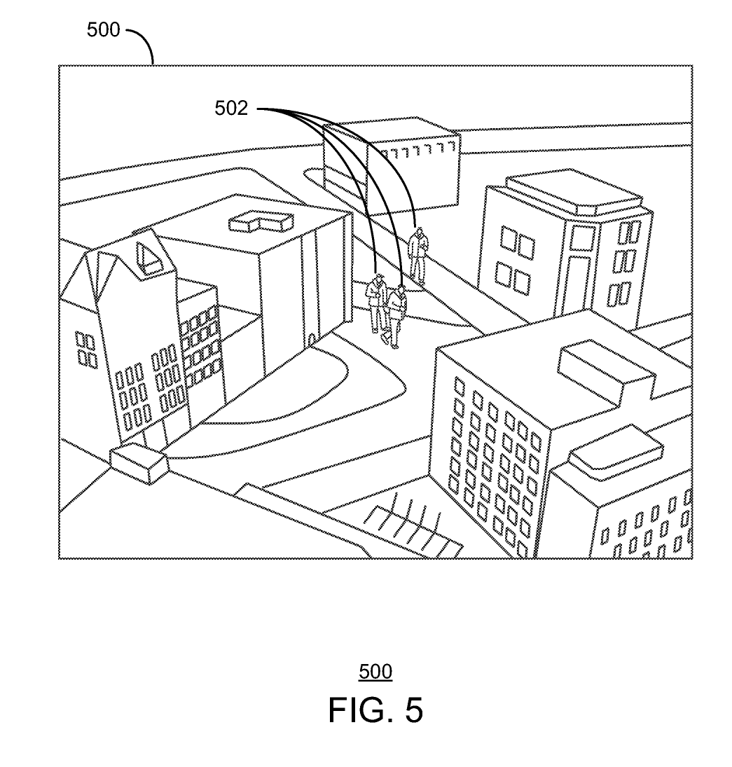

FIG. 5 is a digital map 500 in accordance with the claimed subject matter. The map 500 includes media icons 502 composited with a simple binary mask. The media icons 502 may represent a tour guide at different points of interest on the map 500. The composition makes the media icons 502 appear to be incorporated into the surrounding background.

In some exemplary embodiments, the compositing unit 114 may composite media icons into a map display with a fall-off transparency, as shown in FIGS. 2-5. In FIG. 4, the media icon 402 is composited with a glow outline.

The media selected for the media icons may include recorded or live images, depending on the source. For example, a user may be interested in a guided tour that takes place within the map 500.

The map 500 includes media icons 502 including images of the tour guide located at different points of the tour. The media icons 502 may act as links to initiate playback of prerecorded videos/audio/images/text at corresponding points on the map.

These recordings may be presented to the viewer in response to clicks on the various media icons 502. For example, the viewer may click on one of the media icons 502, and see video of the tour guide revealing a secret entrance to a building on the map 500. Alternatively, the tour guide may give an interactive slide presentation about the history of the building on one of its walls. Presented this way, the tour provides an overall context for the tour via the map 500, and the ability for users to dive deeper into the details via the media icons 502.

As shown, media icons can be used in a variety of applications, including both static and dynamic events. In addition to games at a fixed sports venue, dynamic, moving, events, like a bike race can be represented in a geographical context.

Other sources of media may include information from traffic feeds from cameras along a roadway. Advertising may also be included for media icons at retail outlets such as department stores. Such media icons may include advertising flyers, even video, multimedia, interactive commercial advertising.

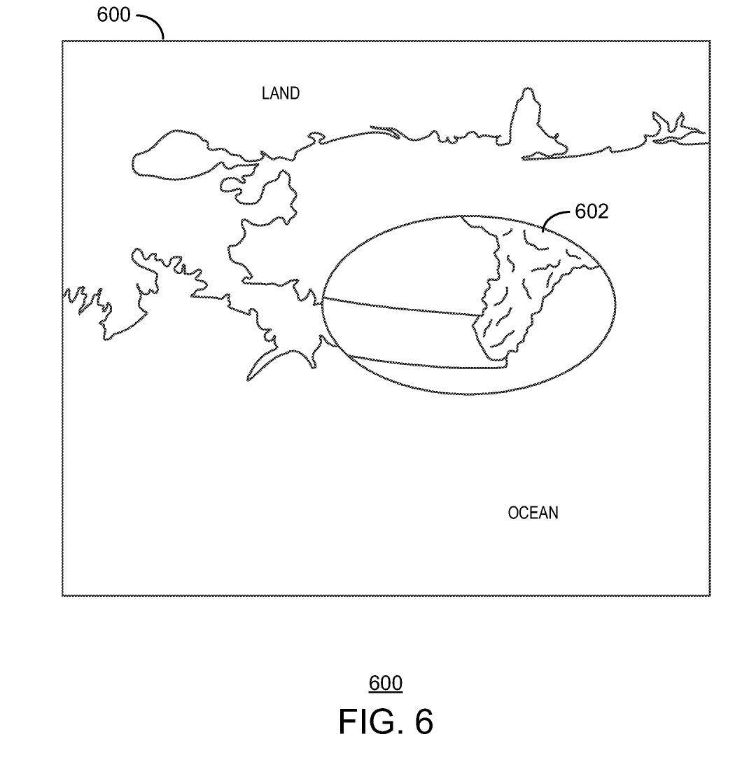

Media icons may be used to represent news or weather events. A map of a large geographical area may have media icons with news feeds for tornadoes, floods, breaking news stories. For example, a news feed of an oil spill may appear as a media icon 602, such as shown in a digital map 600 of FIG. 6. FIG. 6 is the digital map 600 in accordance with the claimed subject matter. As shown, the media icon 602 is composited with a glow outline. Media icons may include videos taken at a specific location (for example, on a street or at an event) and uploaded by users. An exemplary map according to the subject innovation may show a selection of live streams being uploaded by users.

The media icons selected for a particular map may vary based on the implementation. In some cases, predefined user preferences, which may include user interests, may be used to select a media item 104 as a source of media icons for a particular map. In other cases, contextual cues may be used. For example, busy roads and streets may be populated with media icons as traffic along their routes becomes congested.

Some media types are structured and enable easy automation. For example, a traffic camera feed becomes interesting when traffic is slowing down, more than the normal speed. A use of car or motion detection, and a statistics of normal condition can be used to automatically detect times when a particular media is relevant to a particular map.

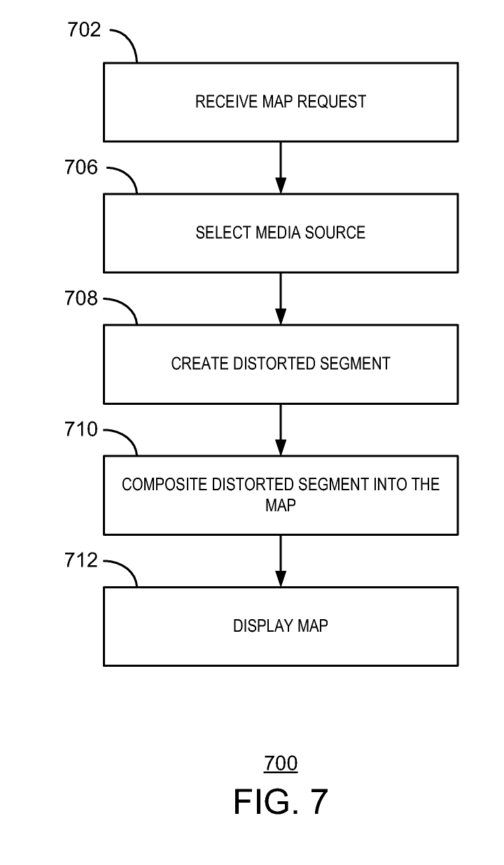

FIG. 7 is a process flow diagram showing a method 700 of producing a map according to an exemplary embodiment of the claimed subject matter. It should be understood that the process flow diagram is not intended to indicate a particular order of execution.

The method 700 begins at block 702 when a user may request a map with media icons. At block 704, a media item may be selected to visually populate a media icon in the map. The media item may be selected based on relevance to the map, and relevance to an interest of the user.

At block 706, a segment may be selected from the media item. As described with reference to FIG. 1, the selected segment may be a portion of an image that is relevant to the map and the user. For example, the baseball player in the image of the baseball field.

At block 708, a distorted segment may be created. The selected segment may be distorted to appear to be oriented to the map. In addition to the other distortions mentioned, the viewing angle may also be distorted. For example, the selected segment may be distorted such that the viewing angle as it appears in the map differs from the viewing angle from which the image was captured.

At block 710, the distorted segment may be composited into the map as a media icon. The media icon may be created from the distorted segment and one of various possible borders or masks. The media icons may then be visually placed within the map.

At block 712, the map may be displayed to the requesting user. As previously described, in some embodiments, the user may interact with the media icons on the map.

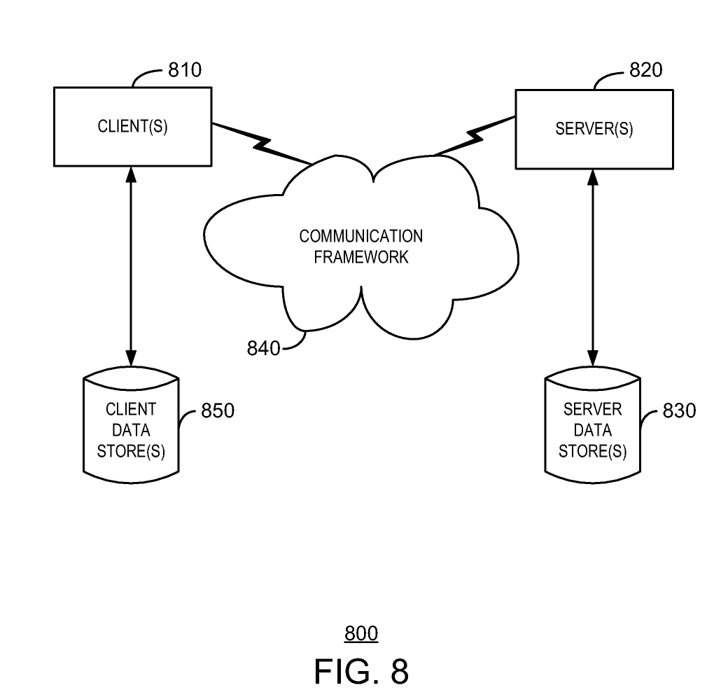

FIG. 8 is a block diagram of an exemplary networking environment 800 wherein aspects of the claimed subject matter can be employed. Moreover, the exemplary networking environment 800 may be used to implement a system and method of generating maps populated with media icons. The media icons may be selected from any of numerous media sources, and be selected to represent relevant events or features within the geographical area of the map.

The networking environment 800 includes one or more client(s) 810. The client(s) 810 can be hardware and/or software (e.g., threads, processes, computing devices).

As an example, the client(s) 810 may be computers providing access, for viewers of the map, to servers over a communication framework 840, such as the Internet.

The system 800 also includes one or more server(s) 820. The server(s) 820 can be hardware and/or software (e.g., threads, processes, computing devices). The server(s) 820 may be map servers accessed by the client 102. The servers 820 can house threads to generate the maps, media icons, and interactions with the clients 810.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820.

The client(s) 810 are operably connected to one or more client data store(s) 850 that can be employed to store information local to the client(s) 810. Such information may include viewing preferences, such as relevant hobbies and interests.

The client data store(s) 850 may be located in the client(s) 810, or remotely, such as in a cloud server. Similarly, the server(s) 820 are operably connected to one or more server data store(s) 830 that can be employed to store information local to the servers 820. Such information may include default viewing options, such as traffic or weather conditions that trigger the generation of a media icon.

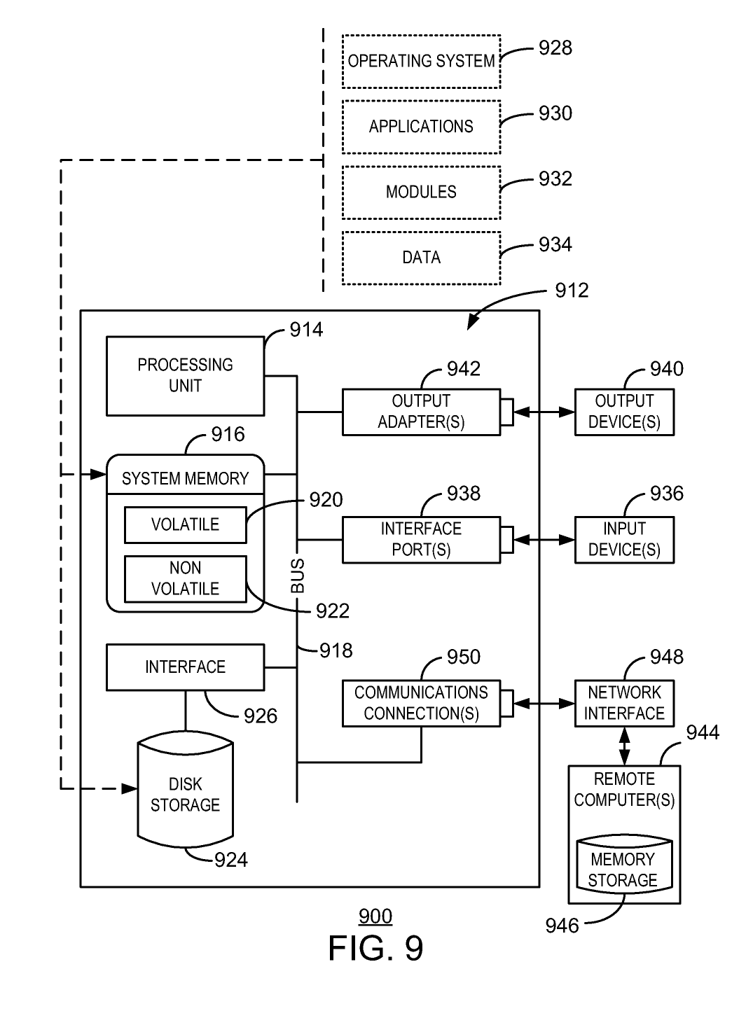

With reference to FIG. 9, an exemplary operating environment 900 for implementing various aspects of the claimed subject matter. The exemplary operating environment 900 includes a computer 912. The computer 912 includes a processing unit 914, a system memory 916, and a system bus 918.

The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures known to those of ordinary skill in the art. The system memory 916 is non-transitory computer-readable media that includes volatile memory 920 and nonvolatile memory 922.

The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory.

Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 912 also includes other non-transitory computer-readable media, such as removable/non-removable, volatile/non-volatile computer storage media. FIG. 9 shows, for example a disk storage 924. Disk storage 924 includes, but is not limited to, devices like a magnetic disk drive, floppy disk drive, tape drive, Jaz drive, Zip drive, LS-100 drive, flash memory card, or memory stick.

In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912.

System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 936 connect to the processing unit 914 through the system bus 918 via interface port(s) 938. Interface port(s) 938 include, for example, a serial port, a parallel port, a game port, and a universal serial bus (USB).

Output device(s) 940 use some of the same type of ports as input device(s) 936. Thus, for example, a USB port may be used to provide input to the computer 912, and to output information from computer 912 to an output device 940.

Output adapter 942 is provided to illustrate that there are some output devices 940 like monitors, speakers, and printers, among other output devices 940, which are accessible via adapters. The output adapters 942 include, by way of illustration and not limitation, video and sound cards that provide a means of connection between the output device 940 and the system bus 918. It can be noted that other devices and/or systems of devices provide both input and output capabilities such as remote computer(s) 944.

The computer 912 can be a server hosting a mapping service in a networked environment using logical connections to one or more remote computers, such as remote computer(s) 944. The remote computer(s) 944 may be client systems configured with web browsers, PC applications, mobile phone applications, and the like, to allow users to access the advertising network, as discussed herein. For example, remote computer 944 may include a web browser that the viewer uses to view and manipulate the generated maps and media icons.

The remote computer(s) 944 can be a personal computer, a server, a router, a network PC, a workstation, a microprocessor based appliance, a mobile phone, a peer device or other common network node and the like, and typically includes many or all of the elements described relative to the computer 912.

For purposes of brevity, only a memory storage device 946 is illustrated with remote computer(s) 944. Remote computer(s) 944 is logically connected to the computer 912 through a network interface 948 and then physically connected via a communication connection 950.

Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to the computer 912. The hardware/software for connection to the network interface 948 may include, for exemplary purposes only, internal and external technologies such as, mobile phone switches, modems including regular telephone grade modems, cable modems and DSL modems, ISDN adapters, and Ethernet cards.

An exemplary embodiment of the computer 912 may comprise a server hosting a mapping service. The server may be configured to generate maps incorporating media icons.

An exemplary processing unit 914 for the server may be a computing cluster comprising Intel® Xeon CPUs. The disk storage 924 may comprise an enterprise data storage system, for example, holding thousands of media items that may serve as a source for media icons as described herein.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for generating a map, comprising:
selecting a media item from a plurality of media items, the media item being relevant to the map and to an interest of a user;
selecting a segment from the media item, the selected segment being relevant to the interest of the user;
creating a distorted segment based on the selected segment, the selected segment being distorted to facilitate positioning the distorted segment in the map; and
compositing the distorted segment into the map as a media icon.

2. The method recited in claim 1, wherein the media item comprises an image, and wherein the segment comprises a portion of the image.

3. The method recited in claim 2, comprising creating the distorted segment by scaling the segment.

4. The method recited in claim 3, comprising creating the distorted segment by rotating the segment.

5. The method recited in claim 3, comprising creating the distorted segment by generating a perspective distortion of the segment.

6. The method recited in claim 3, comprising creating the distorted segment by generating a piecewise affine distortion of the segment.

7. The method recited in claim 3, comprising creating the distorted segment by selecting a different viewing angle for the segment than a viewing angle with which the image is recorded.

8. The method recited in claim 3, wherein compositing the distorted segment comprises:
creating the media icon; and
placing the media icon in the map.

9. The method recited in claim 8, wherein the media icon comprises:
the distorted segment; and
a border based on:
a binary mask;
a fall-off transparency;
a glow outline; or
combinations thereof.

10. The method recited in claim 3, wherein selecting the media comprises selecting an image of traffic in response to a road of the map becoming congested, and wherein the distortion aligns the image to a representation of the road in the map.

11. The method recited in claim 3, wherein the media icon is composited into the map at a location of an event that is related to the interest of the user.

12. The method recited in claim 3, wherein, based on a changing position of an event associated with the media item, the media icon travels:
within the map; or
into a neighboring map.

13. The method recited in claim 12, wherein the distorted segment travels over a same portion of the map repeatedly in response to a request.

14. The method recited in claim 3, wherein the interest of the user comprises one of:
an attraction;
a guided tour;
a sporting event;
a visit to an area of the map;
one or more traffic conditions;
one or more news events;
one or more weather events;
one or more historical events; or
combinations thereof.

15. The method recited in claim 3, wherein the plurality of media items comprise:
an iconic representation;
one or more images;
a video;
a textual description;
an interactive multimedia;
a television station;
a radio station;
a newspaper;
a web log;
a search engine;
a really simple syndication (RSS) feed;
a news feed;
a text message;
an online chat;
a website; or
combinations thereof.

16. A system for generating a map, comprising:
a processing unit; and
a system memory, wherein the system memory comprises code configured to direct the processing unit to:
select a media item from a plurality of media items, the media item being relevant to the map and to an interest of a user;
select a segment from the media item, the segment being relevant to the interest of the user;
scale the selected segment to create a distorted segment;
rotate the distorted segment to facilitate aligning the distorted segment to a portion of the map; and
composite the rotated, distorted segment into the map as a media icon.

17. The system recited in claim 16, wherein the map and the media icon are three-dimensional.

18. One or more computer-readable storage media, comprising code configured to direct a processing unit to:
select a media item from a plurality of media items based on an event that occurs in an area represented by the map;
select a segment from the media item, the segment being relevant to the event;
scale the selected segment to create a distorted segment;
rotate the distorted segment to facilitate aligning the distorted segment to a portion of the map; and
composite the rotated, distorted segment into the map as a media icon, wherein the media icon travels within the map based on a changing location of the event.

19. The computer-readable storage media recited in claim 18, wherein the event is one of:
a traffic condition;
a sporting event;
a historical event;
a personal event; or
combinations thereof.

20. The computer-readable storage media recited in claim 19, wherein the portion of the map comprises one of:
a traffic route;
a walkway;
an attraction;
a building;
a geographical feature; or
combinations thereof.
